(19) United States
(12) Patent Application Publication
(10) Pub. No.: US 2010/0119941 A1
(43) Pub. Date: May 13, 2010

(54) ELECTROCHEMICAL ENERGY SOURCE AND ELECTRONIC DEVICE PROVIDED WITH SUCH AN ELECTROCHEMICAL ENERGY SOURCE

(75) Inventors: Rogier Adrianus Henrica Niessen, Eindhoven (NL); Petrus Henricus Laurentius Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/593,302

(22) PCT Filed: Mar. 31, 2008
(86) PCT No.: PCT/IB2008/051187

§ 371 Date: Sep. 28, 2009

(30) Foreign Application Priority Data
Apr. 2, 2007 (EP) 07105425.8

(51) Int. Cl. H01M 4/58; H01M 4/02; H01M 4/56; H01M 4/54

(52) U.S. Cl. 429/218.2; 429/209; 429/225; 429/219

(57) ABSTRACT

Electrochemical energy sources based on solid-state electrolytes are known in the art. These (planar) energy sources, or ‘solid-state batteries’, efficiently convert chemical energy into electrical energy and can be used as the power sources for portable electronics. The invention relates to an improved electrochemical energy source. The invention also relates to an electronic device provided with such an electrochemical energy source.

### FIELD OF THE INVENTION

The invention relates to an improved electrochemical energy source. The invention also relates to an electronic device provided with such an electrochemical energy source.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO 00/25378, where a solid-state thin-film micro battery is fabricated directly onto a specific substrate. During this fabrication process the first electrode, the intermediate solid-state electrolyte, and the second electrode are subsequently deposited as a stack onto the substrate. The substrate may be flat or curved to realise a two-dimensional or three-dimensional battery stack. It has been found that a major drawback of the known battery is that the active layers of the stack will commonly easily degrade due to an non-optimum choice of layer materials and/or the deposition order of the active layers of the stack. This degradation of one or more active layers may be manifested in that these active layers may decompose, may react with adjacent active layers to form interfacial layers with inferior properties and/or may (re)crystallize to form phases with unwanted properties. Moreover, the manufacturing process of the known micro battery is relatively time-consuming, and hence inefficient.

It is an object of the invention to provide a relatively efficient electrochemical energy source.

### SUMMARY OF THE INVENTION

This object can be achieved by providing an electrochemical energy source according to the preamble, comprising at least one electrochemical cell, each cell comprising: a first electrode deposited onto a first substrate, a second electrode deposited onto a second substrate, and an electrolyte applied in a receiving space formed between said first electrode and said second electrode. Preferably the second electrode faces the first electrode, to allow a flip chip arrangement of cell parts as will be elucidated hereinafter. By depositing the different electrodes onto (commonly) different substrates the electrochemical energy source can be manufactured in a relatively efficient manner, since both electrodes can be deposited and annealed onto different substrates simultaneously, which leads to a considerable saving of manufacturing time. After this deposition step both cell parts can be flip chipped, as a result of which the electrodes will be directed towards each other at a distance from each other. The receiving cavity present between the electrodes will subsequently be filled with the electrolyte. Although expected to be less practical and hence less efficient it would also be conceivable that the first substrate and the second substrate are formed by the same (joint) substrate, wherein both electrodes are deposited aside to each (and not on top of each other), as a result of which both electrodes can still be deposited simultaneously onto the substrate to achieve the advantage of saving of manufacturing time. In this latter case, a flip chip of the (joint) substrate is not necessary to realise the electrochemical energy source according to the invention. Moreover, since both electrodes will be deposited separate from each other, matching of the electrode materials will be significantly less critical compared to the situation in which different layers are deposited on top of each other successively. Gearing the annealing temperatures of the different electrodes is hence not necessary to prevent degradation, and in particular decomposition, of (layers of) the electrochemical cell during annealing of the electrodes. Hence, the electrode materials can be chosen independently from each other and such, that the functionality of these materials to serve as electrode can be optimised in a relatively simple though efficient manner. The first electrode commonly comprises a cathode, and the second electrode commonly comprises an anode (or vice versa). Each electrode commonly also comprises a current collector. By means of the current collectors the cell can easily be connected to an electronic device. Preferably, the current collectors are made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied.

In a preferred embodiment at least one electrode is provided, and more preferably multiple electrodes are provided, with an increased contact surface area facing the electrolyte. In this manner the effective contact surface area between the electrolyte and the electrode(s) is increased substantially with respect to a conventional smooth contact surface of the electrodes, resulting in a proportional increase of the rate capability of the electrochemical energy source according to the invention. Since the contact surface area between both electrodes and the electrolyte may be increased independently from each other, the overall contact surface area, and hence the overall rate capability of the electrochemical energy source according to the invention can be optimised in a relatively efficient manner. Since each electrode material commonly has specific reaction kinetics related characteristics, the pattern of each electrode can be optimised to match the overall reaction kinetics of both electrodes in a relatively accurate manner. This will be considerably beneficial in case a ((re)chargeable) electrochemical cell is required which is intended to operate long-lastingly in a stable manner.

In a particular preferred embodiment a surface of at least one electrode facing the electrolyte is patterned at least partially. In this manner the effective contact surface area between the electrode(s) and the electrolyte is increased substantially with respect to a conventional relatively smooth contact surface of the electrode(s), resulting in a proportional increase of the rate capability of the electrochemical energy source according to the invention. Patterning the surface of one or multiple electrodes facing the electrolyte can be realised by means of various methods, among others selective wet chemical etching, physical etching (Reactive Ion Etching), mechanical imprinting, and chemical mechanical polishing (CMP). The pattern of the electrode(s), increasing the contact surface area between the electrode(s) and the electrolyte, can be shaped in various ways. Preferably, the patterned surface of at least one electrode is provided with multiple cavities, in particular pillars, trenches, slits, or holes, which particular cavities can be applied in a relatively accurate manner. In this manner the increased performance of the electrochemical energy source can also be predetermined in a relatively accurate manner. In a particular preferred embodiment at least one electrode is porous at least partially. By applying one or two porous electrodes the contact surface area of the electrodes can be increased leading to an increased rate capability of the energy source according to the invention. In an alternative preferred embodiment at least one electrode is at least partially provided with multiple surface increasing grains. Various materials may be used to form the surface increasing grains, wherein the size of the grains of the electrode may vary. The surface increasing grains can be applied by means of various methods, e.g. direct physical vapour deposition (PVD), chemical vapour deposition (CVD), in particular wet chemical or sol-gel deposition, of nano-porous thin films or post-treatment of smooth films (resulting in porous films). Highly porous thin films with columnar microstructures can be fabricated using the glancing angle deposition method for physical vapour deposition onto tilted substrates. It is also conceivable to apply a new technique for growing SnO₂ thin films with high surface area which is based on tin rheotaxial growth followed by its thermal oxidation (RGTO). It may be clear for a person skilled in the art that also other methods may be employed to realise the surface increasing grains. The surface increasing grains may be formed by hemispherical grain silicon, also referred to as HSG. Commonly, the top layer is subjected to a surface modification treatment to generate the surface increasing grains. During this treatment the majority of grains, in particular the boundaries of these grains, will commonly fuse slightly to form a porous texture with a relatively high effective surface area. However, in this texture the grains can commonly be individualized, wherein the diameter of the surface increasing grains is preferably substantially lain between 10 and 200 nanometer, preferably between 10 and 60 nanometer. It may be clear that the diameter may exceed this range in case of coalesence of multiple grains. The mutual distance (pitch) between two neighbouring grains is preferably lain between certain nanometers to about 20 nanometer.

In a preferred embodiment the receiving space is at least partially filled with a liquid-state electrolyte. A major advantage of the liquid-state electrolyte is that an intensive and durable contact of the electrolyte with the electrodes, and in particular with a surface of the electrodes having an increased contact surface area can be achieved, as a result of which the performance of the electrochemical energy source according to the invention can be optimised. Another important advantage of applying a liquid-state electrolyte is that liquid-state electrolytes have a relatively high ionic conductivity compared to solid-state electrolytes, which will be beneficial for the impedance of the electrolyte leading to, amongst others, an improved rate capability. Examples of liquid-states electrolytes are lithium salt solutions, wherein e.g. LiClO₄, LiPF₆, and/or LiAsF₆ can be dissolved in propylenecarbonate, di-ethylcarbonate, ethylenecarbonate, and/or di-methylcarbonate. Other liquids which could serve as liquid-state electrolyte are room temperature molten salts, also known as ionic liquids. An ionic liquid is a salt in which the ions are poorly coordinated, which results in these solvents being liquid below 100° C., or even at room temperature (room temperature ionic liquids, RTIL's). At least one ion has a delocalized charge and one component is organic, which prevents the formation of a stable crystal lattice. Methylimidazolium and pyridinium ions have proven to be good starting points for the development of ionic liquids. Properties, such as melting point, viscosity, and solubility of starting materials and other solvents, are determined by the substitutes on the organic component and by the counter ion. Many ionic liquids have even been developed for specific synthetic problems. For this reason, ionic liquids have been termed “designer solvents”. In case of the application of a liquid-state electrolyte, filling of the receiving space by the electrolyte will commonly be relatively simple. Eventually an underpressure can be applied within the receiving space to actively suck the electrolyte into the receiving space. To prevent leakage of the liquid-state electrolyte out of the receiving space, it is commonly advantageous to apply sealing means to seal the receiving space. Instead of liquid-state electrolytes, it is also imaginable to apply gel-type electrolytes, which are also very suitable to be impregnated into the receiving space between both electrodes. Gel-type electrolytes can be prepared mixing a liquid-state electrolyte as set out above with a polymer, such as PMMA, PVP, to make the electrolyte more viscous, commonly provided that the polymer is adapted to be dissolved in relatively high concentrations in the solvent used.

An alternative solution to prevent leakage is to apply a solid-state electrolyte. The solid-state electrolyte is preferably made of at least one material selected from the group consisting of: Li₅La₃Ta₂O₁₂ (Garnet-type class), LiPON, LiNbO₃, LiTaO₃, and Li₉SiAlO₈. Other solid-state electrolyte materials which may be applied smartly are lithium orthotungstate (Li₂WO₄), Lithium Germanium Oxynitride (LiGeON), Li₁₄ZnGe₄O₁₆ (lisicon), Li₃N, beta-aluminas, or Li_{1.3}Ti_{1.7}Al_{0.3}(PO₄)₃ (nasicon-type). A proton conducting electrolyte may for example be formed by TiO(OH), or ZrO₂Hₓ. In a particular preferred embodiment the receiving space is filled at least partially with a polymer-based electrolyte. In this latter case, the electrolyte (to be prepared) can be inserted into the receiving space as a (liquid-state) monomer. After insertion of sufficient monomer into the receiving space, the monomer can be polymerised as to form the actual polymer-based electrolyte.

In a preferred embodiment the cathode is made of at least one material selected from the group consisting of: LiCoO₂, LiMn₂O₄, LiFePO₄, V₂O₅, MoO₃, WO₃, and LiNiO₂. It is has been found that at least these materials are highly suitable to be applied in lithium ion energy sources. Examples of a cathode in case of a proton based energy source are Ni(OH)₂ and NiM(OH)₂, wherein M is formed by one or more elements selected from the group of e.g. Cd, Co, or Bi. It may be clear that also other cathode materials may be used in the electrochemical energy source according to the invention. The anode is preferably made of at least one material selected from the group consisting of: Li metal, Si-based alloys, Sn-based alloys, Al, Si, SnOₓ, Li₄Ti₅O₁₂, SiOₓ, LiSiON, LiSnON, and LiSiSnON, in particular LiₓSiSn_{0.87}O_{1.20}N_{1.72}.

Preferably, at least one electrode of the energy source according to the invention is adapted for storage of active species of at least one of following elements: hydrogen (H), lithium (Li), beryllium (Be), magnesium (Mg), aluminium (Al), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of (reserve-type) battery cells, e.g. Li-ion battery cells, NiMH battery cells, et cetera. In a preferred embodiment at least one electrode, more particularly the battery anode, comprises at least one of the following materials: C, Sn, Ge, Pb, Zn, Bi, Sb, Li, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anode, preferably any other suitable element which is assigned to one of groups 12-16 of the periodic table, provided that the material of the battery electrode is adapted for intercalation and storing of the abovementioned reactive species. The aforementioned materials are in particularly suitable to be applied in lithium ion based battery cells. In case a hydrogen based battery cell is applied, the anode preferably comprises a hydride forming material, such as AB₅-type materials, in particular LaNi₅, and such as magnesium-based alloys, in particular MgₓTi₁₋ₓ.

The electrochemical energy source preferably comprises at least one barrier layer being deposited between the substrate and at least one electrode, which barrier layer is adapted to at least substantially preclude diffusion of active species of the cell into said substrate. In this manner the substrate and the electrochemical cell will be separated chemically, as a result of which the performance of the electrochemical cell can be maintained relatively long-lastingly. In case a lithium ion based cell is applied, the barrier layer is preferably made of at least one of the following materials: Ta, TaN, Ti, and TiN. It may be clear that also other suitable materials may be used to act as barrier layer. Commonly, it will be beneficial to position the barrier layer between the anode and the adjacent substrate.

In a preferred embodiment preferably a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. As mentioned afore, beside relatively rigid materials, also substantially flexible materials, such as e.g. foils like Kapton® foil, may be used for the manufacturing of the substrate. It may be clear that also other suitable materials may be used as a substrate material.

The invention also relates to an electronic device provided with at least one electrochemical energy source according to the invention, and at least one electronic component connected to said electrochemical energy source. The at least one electronic component is preferably at least partially embedded in the substrate of the electrochemical energy source. In this manner a System in Package (Sip) may be realized. In a SiP one or multiple electronic components and/or devices, such as integrated circuits (ICs), actuators, sensors, receivers, transmitters, et cetera, are embeddded at least partially in the substrate of the electrochemical energy source according to the invention. The electrochemical energy source according to the invention is ideally suitable to provide power to relatively small high power electronic applications, such as (bio)implantantables, hearing aids, autonomous network devices, and nerve and muscle stimulation devices, and moreover to flexible electronic devices, such as textile electronics, washable electronics, applications requiring pre-shaped batteries, e-paper and a host of portable electronic applications.

### BRIEF DESCRIPTION OF THE DRAWINGS

The invention is illustrated by way of the following non-limitative examples, wherein:

FIG. 1 shows a cross-section of an electrochemical energy source according to the invention,

FIGS. 2a-2d shows the manufacturing of the electrochemical energy source according to FIG. 1,

FIGS. 3a-3b shows a detailed cross-section of a part of the electrochemical energy source according to FIG. 1, and

FIG. 4 shows a cross-section of another electrochemical energy source according to the invention.

### DETAILED DESCRIPTION OF THE EMBODIMENTS

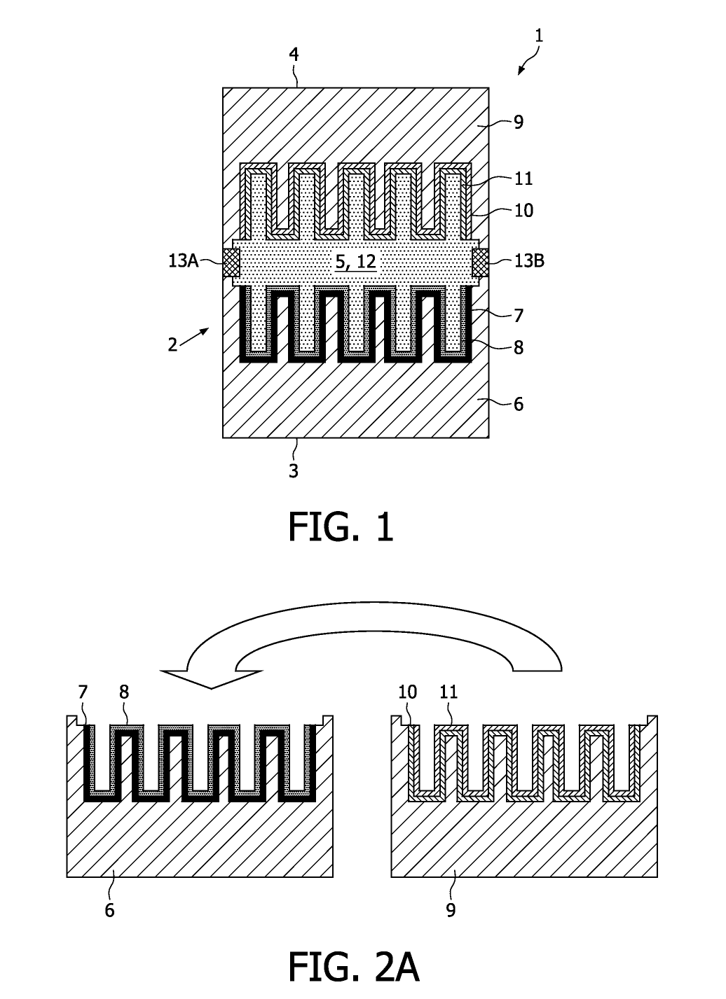

FIG. 1 shows an electrochemical energy source 1 according to the invention, comprising a lithium ion battery cell 2, said battery cell 2 comprising a first cell part 3, a second cell part 4, and a liquid-state electrolyte 5 applied in between the first cell part 3 and the second cell part 4. The first cell part 3 comprises a first substrate 6 onto which a first current collector 7 and an anode 8 have been deposited subsequently. The first current collector 7 also acts as barrier layer to preclude diffusion of active species initially contained by the anode 8 into the first substrate 6. The second cell part 4 comprises a second substrate 9 onto which a second current collector 10 and a cathode 11 have been deposited. A receiving space 12 for the electrolyte 5 has been sealed by means of sealing seams 13a, 13b. In this figure it is shown clearly that both substrates 6, 9 are patterned, and that hence both the anode 8 and the cathode 11 are patterned in order to increase the contact surface area between both respective electrodes 8, 11 and the electrolyte 5, and hence the performance of the battery cell 2.

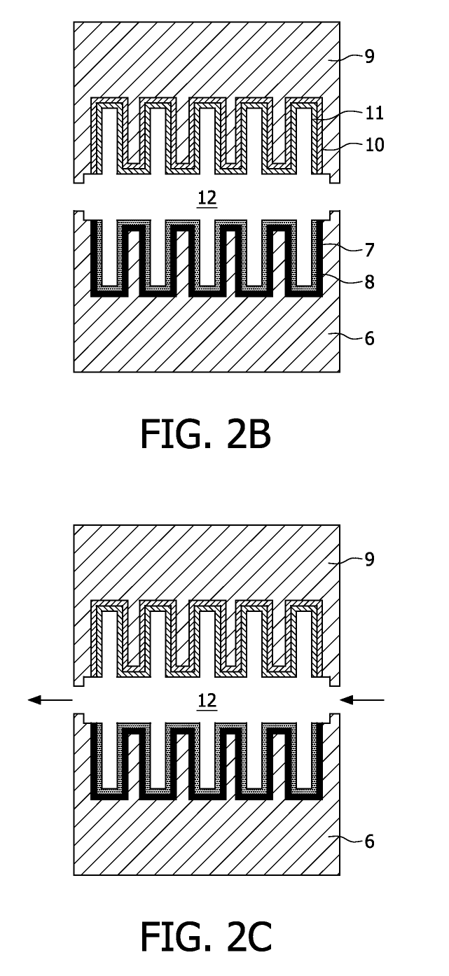

FIGS. 2a-2d shows the manufacturing of the electrochemical energy source 1 according to FIG. 1. As shown in FIG. 2a, the first step is to prepare both cell parts 3, 4. To this end, the first current collector 7 and the anode 8 are deposited subsequently onto the first substrate 6, and the second current collector 10 and the cathode 11 are deposited subsequently onto the second substrate 9. After preparation of the cell parts 3, 4, the second cell part 4 is flip chipped onto the first cell part 3 (see arrow), wherein both electrodes 8, 11 are directed towards each other, at a distance of each other (see FIG. 2a). The receiving space 12 between both cell parts 3, 4 is subjected subsequently to an underpressure (see left arrow in FIG. 2c) and liquid-state electrolyte 5 is inserted into the receiving space 12 (see right arrow in FIG. 2d). After filling the receiving space 12 with the electrolyte 5, the receiving space is sealed by means of sealing seams 13a, 13b (see FIG. 2d). Deposition of the individual layers 7, 8, 10, 11 can be achieved, for example, by means of CVD, sputtering, E-beam deposition or sol-gel deposition. Patterning both substrates 6, 9 may be realised e.g. by wet chemical etching, physical etching (Reactive Ion Etching), mechanical imprinting, and chemical mechanical polishing (CMP).

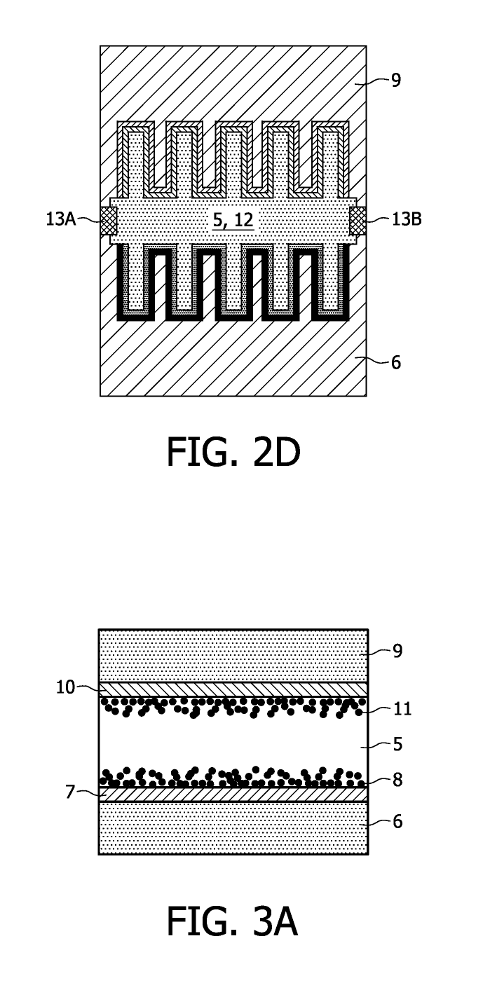

FIGS. 3a-3b shows a detailed cross-section of a part of the electrochemical energy source 1 according to FIG. 1. More in particular, FIG. 3a shows in more detail that both the anode 8 and the cathode 11 have been deposited as surface increasing nano-grains to further increase the contact surface area between the electrodes 8, 11 and the electrolyte 5. Both current collectors 7, 10 have been deposited as closed, smooth layers onto the substrates 6, 9 respectively. In FIG. 3b it is shown in even more detail that the substrates 6, 9 (of which presently merely the first substrate 6 is shown) may be provided with a microstructure 14 onto which the first current collector 7 and the anode 8 are deposited subsequently to even further increase the contact surface area between the electrodes 8, 11 and the electrolyte 5.

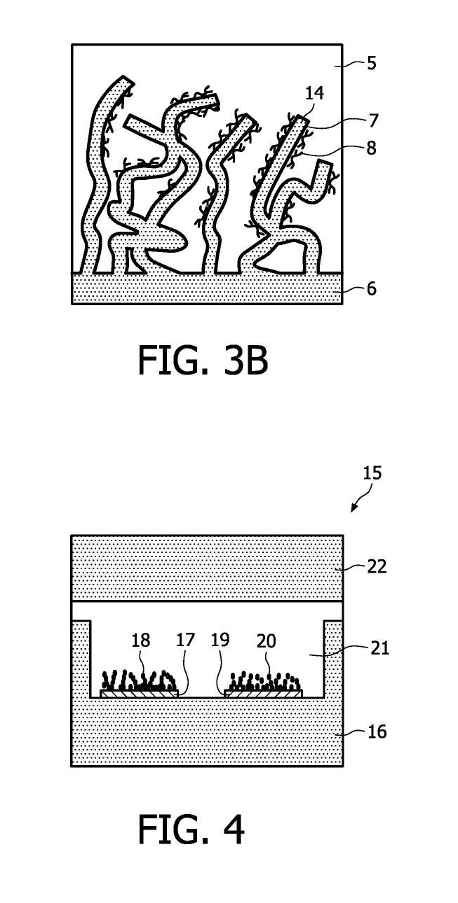

FIG. 4 shows a cross-section of another electrochemical energy source 15 according to the invention. The energy source 15 comprises a cup shaped base substrate 16 on top of which a first current collector 17 and a patterned anode 18 provided with surface increasing grains have been deposited subsequently. Moreover, on top of the base substrate 16 a second current collector 19 and a patterned cathode 20 provided with surface increasing grains have been deposited at a distance from the first current collector 17 and the anode 18. Subsequently, the cup shaped base substrate 16 is filled with a liquid-state and/or solid-state electrolyte 21 to finalise the electrochemical energy source 15. Optionally, a top substrate 22 is applied to protect the active layers 18, 20, 21 of the electrochemical energy source 15, and to generate a closed receiving cavity for the electrolyte 21. In case merely a liquid-state electrolyte 21 is used, preferably a seal (not shown) is applied between the base substrate 16 and the top substrate 22.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising at least one electrochemical cell, each cell comprising:
a first electrode deposited onto a first substrate,
a second electrode deposited onto a second substrate, and
an electrolyte applied in a receiving space formed between said first electrode and said second electrode.

2. Electrochemical energy source according to claim 1, characterized in that the first electrode comprises a cathode, and/or that the second electrode comprises an anode.

3. Electrochemical energy source according to claim 1, characterized in that the first electrode faces the second electrode.

4. Electrochemical energy source according to claim 1, characterized in that at least one electrode is provided with an increased contact surface area facing the electrolyte.

5. Electrochemical energy source according to claim 4, characterized in that both electrodes are provided with an increased contact surface area facing the electrolyte.

6. Electrochemical energy source according to claim 4, characterized in that a surface of at least one electrode facing the electrolyte is patterned at least partially.

7. Electrochemical energy source according to claim 6, characterized in that the at least one patterned surface of the at least one electrode is provided with at least one cavity.

8. Electrochemical energy source according to claim 7, characterized in that at least a part of the at least one cavity form pillars, trenches, slits, or holes.

9. Electrochemical energy source according to claim 4, characterized in that at least one electrode is porous at least partially.

10. Electrochemical energy source according to claim 4, characterized in at least one electrode is at least partially provided with multiple surface increasing grains.

11. Electrochemical energy source according to claim 1, characterized in that the receiving space is at least partially filled with a liquid-state electrolyte.

12. Electrochemical energy source according to claim 1, characterized in that the receiving space is at least partially filled with a solid-state electrolyte.

13. Electrochemical energy source according to claim 1, characterized in that the electrochemical energy source comprises sealing means for substantially sealing the receiving space after insertion of the electrolyte into the receiving space.

14. Electrochemical energy source according to claim 2, characterized in that both the anode and the cathode are adapted for storage of active species of at least one of following elements: H, Li, Be, Mg, Cu, Ag, Na and K.

15. Electrochemical energy source according to claim 2, characterized in that at least one of the anode and the cathode is made of at least one of the following materials: C, Sn, Ge, Pb, Zn, Bi, Li, Sb, and, preferably doped, Si.

16. Electrochemical energy source according to claim 1, characterized in that the first electrode and the second electrode each comprises a current collector.

17. Electrochemical energy source according to one claim 16, characterized in that the at least one current collector is made of at least one of the following materials: Al, Ni, Pt, Au, Ag, Cu, Ta, Ti, TaN, and TiN.

18. Electrochemical energy source according to claim 1, characterized in that the energy source further comprises at least one electron-conductive barrier layer being deposited between the substrate and at least one electrode, which barrier layer is adapted to at least substantially preclude diffusion of active species of the cell into said substrate.

19. Electrochemical energy source according to claim 18, characterized in that the at least one barrier layer is made of at least one of the following materials: Ta, TaN, Ti, and TiN.

20. Electrochemical energy source according to claim 1, characterized in that at least one substrate comprises at least one of the following materials: C, Si, Sn, Ti, Ge, Al, Cu, Ta, and Pb.

21. Electrochemical energy source according to claim 1, characterized in that at least one substrate is made of a flexible material.

22. Electronic device, comprising at least one electrochemical energy source according to claim 1, and at least electronic component connected to said electrochemical energy source.

23. Electronic device according to claim 22, characterized in that the at least one electronic component is at least partially embedded in the substrate of the electrochemical energy source.

24. Electronic device according to claim 22, characterized in that the at least one electronic component is chosen from the group consisting of: sensing means, pain relief stimulating means, communication means, and actuating means.

25. Electronic device according to claim 22, characterized in that the electronic device and the electrochemical energy source form a System in Package (SiP).
